(19) United States
(12) Patent Application Publication
(10) Pub. No.: US 2017/0093696 A1
(43) Pub. Date: Mar. 30, 2017

(54) Relay Device and Relay System

(71) Applicant: Hitachi Metals, Ltd., Tokyo (JP)

(72) Inventors: Kazutoshi KARIYA, Tsuchiura (JP); Daisuke FUKADA, Kasumigaura (JP); Shingo SUGAWARA, Tsuchiura (JP)

(21) Appl. No.: 15/011,907

(22) Filed: Feb. 1, 2016

(30) Foreign Application Priority Data
Sep. 29, 2015 (JP) 2015-191550

(51) Int. Cl. H04L 12/703; H04L 12/26; H04L 25/20; H04L 12/46; H04L 29/12

(52) U.S. Cl. CPC H04L 45/28; H04L 12/4641; H04L 61/6022; H04L 25/20; H04L 43/0823

(57) ABSTRACT

A logical port table retains a combination of a physical port and a VLAN identifier in association with a logical port. An FDB retains a correspondence relation between a MAC address and the logical port. When a frame is received at the physical port, a table processing unit acquires the logical port based on the logical port table. An FDB processing unit learns a source MAC address contained in the frame in association with the logical port acquired by the table processing unit to the FDB.

### CROSS-REFERENCE TO RELATED APPLICATION

The present application claims priority from Japanese Patent Application No. 2015-191550 filed on Sep. 29, 2015, the content of which is hereby incorporated by reference into this application.

### TECHNICAL FIELD OF THE INVENTION

The present invention relates to a relay device and a relay system, for example, a relay device and a relay system to which a ring network is applied.

### BACKGROUND OF THE INVENTION

For example, Japanese Patent Application Laid-Open Publication No. 2008-136013 (Patent Document 1) describes a method in which a monitoring device is provided in a ring network and the presence or absence of fault in the ring network is monitored by the monitoring device. Specifically, the monitoring device controls open/close of a ring port depending on whether a health check frame transmitted from one ring port can be received at the other, and further transmits a flush request frame of requesting to erase learning information from a ring port at the time of the open/close switching. In addition, Patent Document 1 further describes a monitoring method in the case where two ring networks are connected to two shared devices connected via a shared link.

### SUMMARY OF THE INVENTION

For example, a ring network using various ring protocols has been widely known as one of network topologies. As described in Patent Document 1 and others, in a ring network, open/close of a predetermined ring port is generally controlled depending on the presence or absence of fault in the ring network, and an FDB (Forwarding DataBase) is flushed (erased) at the time of the open/close switching. The FDB retains a plurality of entries including a correspondence relation between MAC address and port. At the time of FDB flushing, for example, by designating a predetermined ring port as a port, the entries including the ring port are erased.

Here, for example, when two ring networks are connected to a relay device, the two ring networks are generally connected to different ring ports in the relay device, respectively. This is because when two ring networks are connected to one ring port, if a fault occurs in one ring network and FDB flushing is performed with designating the one ring port, the entries in an FDB belonging to the other ring network are also erased. However, when a ring port is provided for each ring network in this way, the number of ports increases and the number of communication lines (for example, the number of optical fibers) increases, which leads to the increase in cost.

The present invention has been made in view of the problems mentioned above, and an object thereof is to provide a relay device and a relay system capable of achieving the cost reduction.

The above and other objects and novel characteristics of the present invention will be apparent from the description of the present specification and the accompanying drawings.

The following is a brief description of an outline of the typical invention disclosed in the present application.

A relay device according to one embodiment includes: a physical port; a logical port table; a table processing unit; an FDB; and an FDB processing unit. The logical port table retains a combination of the physical port and a VLAN identifier in association with a logical port. The FDB retains a correspondence relation between a MAC address and the logical port. When a frame is received at the physical port, the table processing unit acquires the logical port from the physical port which has received the frame and the VLAN identifier contained in the frame based on the logical port table. The FDB processing unit learns a source MAC address contained in the frame in association with the logical port acquired by the table processing unit to the FDB.

The advantages obtained by representative embodiments in the present invention disclosed in the present application will be briefly described as follows. That is, the cost reduction can be achieved in the relay device and the relay system.

### BRIEF DESCRIPTIONS OF THE DRAWINGS

FIG. 1A is a block diagram illustrating a schematic configuration example of main components in a relay device according to the first embodiment of the present invention;

FIG. 1B is a schematic diagram illustrating a configuration example of a logical port table of FIG. 1A;

FIG. 1C is a schematic diagram illustrating a configuration example of an FDB of FIG. 1A;

FIG. 2 is a schematic diagram illustrating a configuration example of a relay system according to the second embodiment of the present invention;

FIG. 3A is a block diagram illustrating a schematic configuration example of main components in the relay device of FIG. 2;

FIG. 3B is a schematic diagram illustrating a configuration example of a logical port table of FIG. 3A;

FIG. 3C is a schematic diagram illustrating a configuration example of an FDB of FIG. 3A;

FIG. 4 is an explanatory diagram illustrating a main operation example in the occurrence of fault in the relay system of FIG. 2;

FIG. 5 is a block diagram illustrating a configuration example of main components in a relay device according to the third embodiment of the present invention;

FIG. 6 is a block diagram illustrating a configuration example of a high-bandwidth line card in the relay device of FIG. 5;

FIG. 7A is a schematic diagram illustrating a configuration example of ingress/egress LP tables of FIG. 6;

FIG. 7B is a schematic diagram illustrating a configuration example of ingress/egress VID conversion tables of FIG. 6;

FIG. 7C is a schematic diagram illustrating a configuration example of an FDB of FIG. 6;

FIG. 8 is a schematic diagram illustrating a configuration example in the case where the relay device of FIG. 5 is applied to the relay system of FIG. 2;

FIG. 9 is an explanatory diagram illustrating a schematic operation example of the relay device of FIGS. 5 and 6;

FIG. 10 is a schematic diagram illustrating a configuration example of a relay system according to the fourth embodiment of the present invention;

FIG. 11A is a block diagram illustrating a schematic configuration example of main components in a relay device according to a comparative example of the present invention;

FIG. 11B is a schematic diagram illustrating a configuration example of an FDB of FIG. 11A;

FIG. 12A is a schematic diagram illustrating a configuration example of a relay system studied as a comparative example of FIG. 2;

FIG. 12B is a diagram illustrating an example of contents retained in an FDB in the relay device of FIG. 12A;

FIG. 13A is a schematic diagram illustrating another configuration example of the relay system studied as the comparative example of FIG. 2; and

FIG. 13B is a diagram illustrating an example of contents retained in an FDB in the relay device of FIG. 13A.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle, and the number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments of the present invention will be described in detail with reference to the accompanying drawings. Note that components having the same function are denoted by the same reference characters throughout the drawings for describing the embodiments, and the repetitive description thereof will be omitted.

### First Embodiment

### Basic Configuration of Relay Device

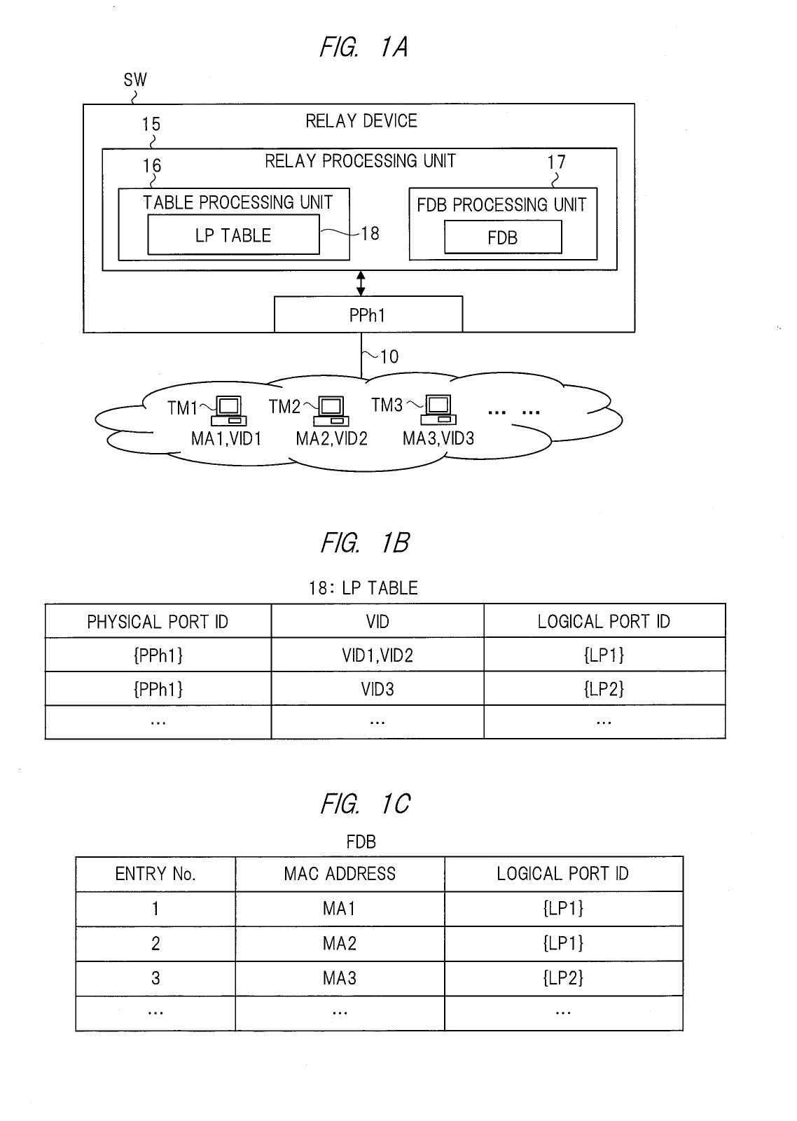

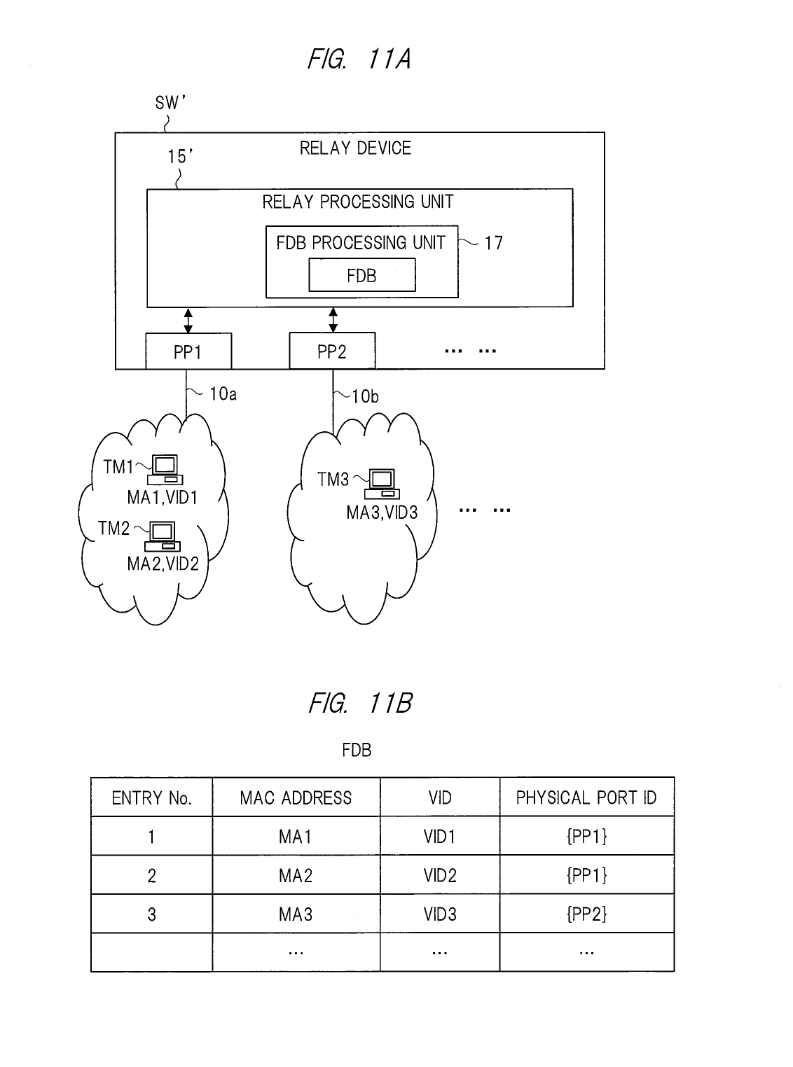

FIG. 1A is a block diagram illustrating a schematic configuration example of main components in a relay device according to the first embodiment of the present invention, FIG. 1B is a schematic diagram illustrating a configuration example of a logical port table of FIG. 1A, and FIG. 1C is a schematic diagram illustrating a configuration example of an FDB of FIG. 1A. FIG. 11A is a block diagram illustrating a schematic configuration example of main components in a relay device according to a comparative example of the present invention and FIG. 11B is a schematic diagram illustrating a configuration example of an FDB of FIG. 11A.

First, a relay device SW′ according to the comparative example illustrated in FIG. 11A includes a plurality of physical ports PP1, PP2, . . . , and a relay processing unit 15′. The relay processing unit 15′ includes an FDB and an FDB processing unit 17 which performs learning and retrieval of the FDB. In the example of FIG. 11A, terminals TM1 and TM2 are present ahead of a communication line 10a connected to the physical port PP1 and a terminal TM3 is present ahead of a communication line 10b connected to the physical port PP2. The terminals TM1, TM2 and TM3 have the MAC addresses “MA1”, “MA2” and “MA3” and the VLAN identifiers “VID1”, “VID2” and “VID3” are respectively allocated thereto.

In this case, as illustrated in FIG. 11B, the port identifier {PP1} is learned in association with “MA1” and “VID1” to the FDB. The port identifier {PP1} indicates the identifier (ID) of the physical port PP1, and for example, {AA} is supposed to indicate the identifier of “AA” in the same manner in the present specification. Further, the port identifier {PP1} is learned in association with “MA2” and “VID2” and the port identifier {PP2} is learned in association with “MA3” and “VID3” to the FDB of FIG. 11B.

A relay device SW illustrated in FIGS. 1A to 1C realizes a configuration equivalent to the relay device SW′ of FIG. 11A by one physical port. Though not particularly limited, the relay device SW illustrated in FIG. 1A is a layer 2 (L2) switch or the like for performing an L2 processing of an OSI reference model, and includes a physical port PPh1 and a relay processing unit 15. The relay processing unit 15 includes a logical port table (hereinafter, abbreviated as LP table below) 18, a table processing unit 16 for performing processing based on the LP table, an FDB, and the FDB processing unit 17 for performing learning and retrieval of the FDB.

In the example of FIG. 1A, unlike the case of FIG. 11A, the terminals TM1, TM2 and TM3 similar to those in FIG. 11A are present ahead of a communication line 10 connected to the physical port PPh1. In this case, the LP table 18 previously retains combinations of the one physical port PPh1 and one or a plurality of VLAN identifiers in association with one logical port based on the user setting as illustrated in FIG. 1B. Specifically, the LP table 18 retains a combination of the port identifier {PPh1} and the VLAN identifiers “VID1” and “VID2” in association with the logical port LP1 (port identifier {LP1}), and retains a combination of the port identifier {PPh1} and the VLAN identifier “VID3” in association with the logical port LP2 (port identifier {LP2}).

The logical port LP1 is a port equivalent to the physical port PP1 of FIG. 11A, and the logical port LP2 is a port equivalent to the physical port PP2 of FIG. 11A. In this way, the logical ports provide a mechanism for virtually mounting a plurality of physical ports on the one physical port PPh1. If there are ten physical ports and a bandwidth of each physical port is 10 Gbps in FIG. 11A, this configuration can be replaced with the configuration of FIG. 1A by providing the physical port PPh1 having a bandwidth of 100 Gbps and then providing ten logical ports on the physical port.

When a frame is received at the physical port PPh1, the table processing unit 16 acquires the logical port based on the logical port table 18. The FDB processing unit 17 learns a source MAC address contained in the frame in association with the logical port acquired by the table processing unit 16 to the FDB. Specifically, when a frame containing the source MAC address “MA1” and the VLAN identifier “VID1” from the terminal TM1 is received at the physical port PPh1, the table processing unit 16 acquires the port identifier {LP1} from the physical port PPh1 and the VLAN identifier “VID1” based on the logical port table 18. The FDB processing unit 17 learns the source MAC address “MA1” in association with the port identifier {LP1} to the FDB as illustrated in FIG. 1C.

Similarly, when a frame from the terminal TM2 is received at the physical port PPh1, the table processing unit 16 acquires the port identifier {LP1}. The FDB processing unit 17 learns the source MAC address “MA2” of the frame in association with the port identifier {LP1} to the FDB. Further, when a frame from the terminal TM3 is received at the physical port PPh1, the table processing unit 16 acquires the port identifier {LP2}. The FDB processing unit 17 learns the source MAC address “MA3” of the frame in association with the port identifier {LP2} to the FDB.

Further, when a frame containing the destination MAC address “MA1” is received at, for example, a physical port (not illustrated), the FDB processing unit 17 retrieves the FDB with using “MA1” as a retrieval key, and acquires the port identifier {LP1} to be a destination (referred to as a destination port identifier). When the destination port identifier is the port identifier of the logical port, the table processing unit 16 replaces the destination port identifier {LP1} with the port identifier of the physical port (here, {PPh1}) based on the logical port table 18. The relay processing unit 15 relays the received frame to the physical port PPh1 corresponding to the destination port identifier {PPh1}.

Here, for example, the FDB processing unit 17 learns the MAC address “MA1” in association with the port identifier {LP1} to the FDB in response to the frame from the terminal TM1, but may additionally learn the VLAN identifier “VID1”. In this case, in the destination retrieval described above, the FDB processing unit 17 retrieves the FDB with using “MA1” and “VID1” as retrieval keys.

As described above, the cost reduction or the like can be mainly achieved by use of the relay device according to the first embodiment. Namely, by using the configuration of FIG. 1A, a plurality of physical ports and a plurality of communication lines (for example, optical fibers) which are required in the configuration of FIG. 11A can be replaced with one physical port and one communication line.

### Second Embodiment

### Schematic Configuration of Relay System

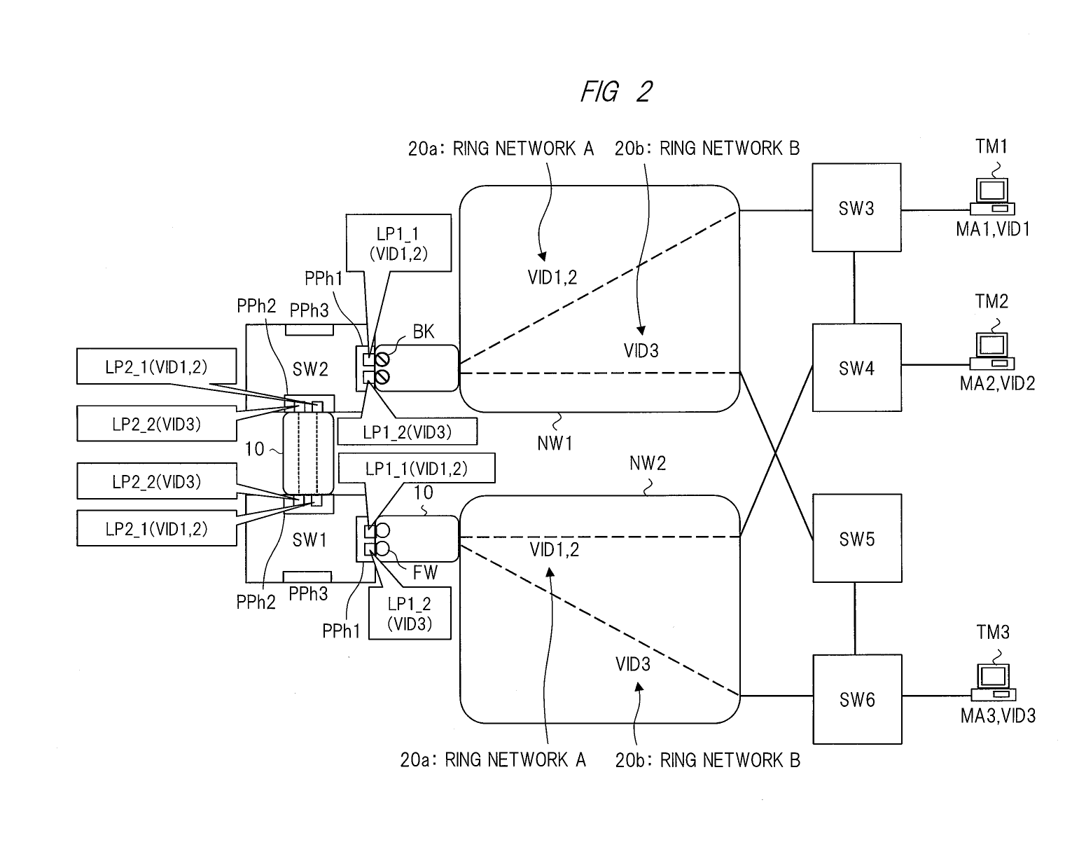

FIG. 2 is a schematic diagram illustrating a configuration example of a relay system according to the second embodiment of the present invention. The relay system illustrated in FIG. 2 includes a plurality of relay devices connected via a communication line. In FIG. 2, the relay devices SW1 to SW6 are, for example, L2 switches and others. In addition, the relay system illustrated in FIG. 2 includes networks NW1 and NW2 in which relaying based on VLAN identifiers is performed. Each of the networks NW1 and NW2 is made up of relay devices, communication lines and the like as needed and TE (Traffic Engineering) or the like is applied thereto.

When a frame containing the VLAN identifier “VID1” or “VID2” from the relay device SW2 is received, the network NW1 relays the frame to the relay device SW3, and when a frame containing “VID3” is received, the network NW1 relays the frame to the relay device SW5. Also, when a frame containing “VID1” or “VID2” from the relay device SW3 is received or when a frame containing “VID3” from the relay device SW5 is received, the network NW1 relays the frame to the relay device SW2.

When a frame containing the VLAN identifier “VID1” or “VID2” from the relay device SW1 is received, the network NW2 relays the frame to the relay device SW4, and when a frame containing “VID3” is received, the network NW2 relays the frame to the relay device SW6. Also, when a frame containing “VID1” or “VID2” from the relay device SW4 is received or when a frame containing “VID3” from the relay device SW6 is received, the network NW2 relays the frame to the relay device SW1.

Each of the relay devices SW1 and SW2 includes three physical ports PPh1 to PPh3. The physical ports PPh2 of the relay devices SW1 and SW2 are connected via the communication line 10. The physical port PPh1 of the relay device SW1 is connected to the network NW2 via the communication line 10, and the physical port PPh1 of the relay device SW2 is connected to the network NW1 via the communication line 10. Also, the relay device SW3 and the relay device SW4 are connected via a communication line and the relay device SW5 and the relay device SW6 are connected via a communication line outside the networks NW1 and NW2.

With this configuration, as illustrated in FIG. 2, a ring network A (20a) made up of the relay devices SW1→SW2→NW1→SW3→SW4→NW2→SW1 and a ring network B (20b) made up of the relay devices SW1→SW2→NW1→SW5→SW6→NW2→SW1 are constructed. Here, the logical ports described in the first embodiment are applied to the relay devices SW1 and SW2.

The physical ports PPh1 of the relay devices SW1 and SW2 are both ring ports shared by the ring network A (20a) and the ring network B (20b), and a plurality of (here, two) logical ports LP1_1 and LP1_2 described in the first embodiment are set. Similarly, the physical ports PPh2 of the relay devices SW1 and SW2 are both ring ports shared by the ring network A (20a) and the ring network B (20b), and a plurality of (here, two) logical ports LP2_1 and LP2_2 are set.

In the example of FIG. 2, the terminal TM1 is connected to the relay device SW3, the terminal TM2 is connected to the relay device SW4, and the terminal TM3 is connected to the relay device SW6. The terminals TM1, TM2 and TM3 respectively have the MAC addresses “MA1”, “MA2” and “MA3” and the VLAN identifiers “VID1”, “VID2” and “VID3” are respectively allocated thereto. Accordingly, “VID1” or “VID2” is allocated to the ring network A (20a) and “VID3” is allocated to the ring network B (20b).

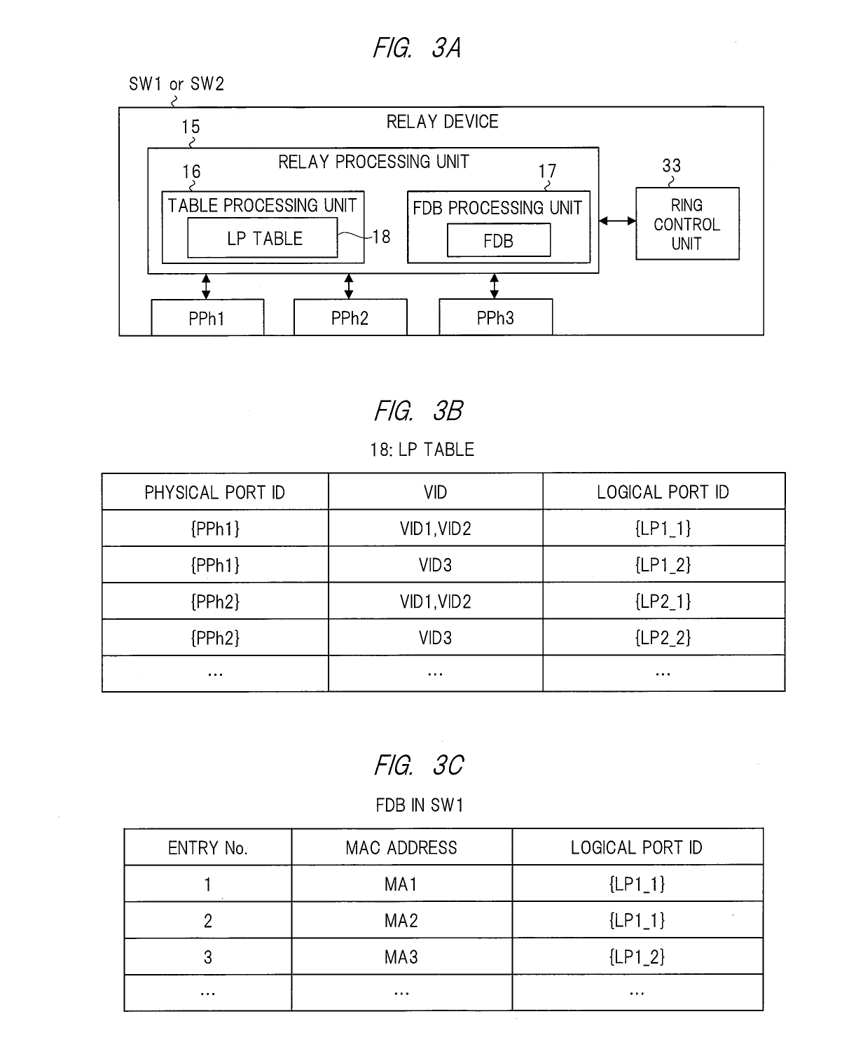

FIG. 3A is a block diagram illustrating a schematic configuration example of main components in the relay device of FIG. 2, FIG. 3B is a schematic diagram illustrating a configuration example of a logical port table of FIG. 3A, and FIG. 3C is a schematic diagram illustrating a configuration example of an FDB of FIG. 3A. FIG. 3A illustrates a schematic configuration example of the relay device SW1 (or SW2) of FIG. 2. The relay device SW1 includes three physical ports PPh1 to PPh3 and a ring control unit 33 in addition to the relay processing unit 15 similar to that in FIG. 1A. The ring control unit 33 controls the ring networks A and B (20a and 20b) based on a predetermined ring protocol.

Here, in the LP table 18 of FIG. 3A, as illustrated in FIG. 3B, the port identifier {LP1_1} corresponding to the port identifier {PPh1} and “VID1” and “VID2” is set, and the port identifier {LP1_2} corresponding to the port identifier {PPh1} and “VID3” is set. In this manner, the logical port LP1_1 becomes a port equivalent to a physical ring port connected to the ring network A (20a), and the logical port LP1_2 becomes a port equivalent to another physical ring port connected to the ring network B (20b).

Similarly, in the LP table 18, the port identifier {LP2_1} corresponding to the port identifier {PPh2} and “VID1” and “VID2” is set, and the port identifier {LP2_2} corresponding to the port identifier {PPh2} and “VID3” is set. In this manner, the logical port LP2_1 becomes a port equivalent to a physical ring port connected to the ring network A (20a), and the logical port LP2_2 becomes a port equivalent to another physical ring port connected to the ring network B (20b).

With reference to FIG. 2 again, though not particularly limited here, the two relay devices SW1 and SW2 are in the device redundancy configuration, and monitor the presence or absence of fault in a ring network and prevent a loop path. In this example, the ring control unit 33 in the relay device SW2 controls the logical port LP1_1 to the transmission/reception prohibited state (so-called block port) BK, thereby preventing a loop path in the ring network A (20a), and controls the logical port LP1_2 to the transmission/reception prohibited state BK, thereby preventing a loop path in the ring network B (20b). In this way, the ring control unit 33 can control the block ports in units of logical port.

For example, the ring control unit 33 in the relay device SW2 transmits a fault monitoring control frame from the logical port LP1_1 at regular intervals, and monitors the presence or absence of fault in the ring network A (20a) depending on whether the frame can be received at the logical port LP1_1 in the switching device SW1. When the control frame can be received within a predetermined period of time (in the absence of fault), the ring control unit 33 controls the logical port LP1_1 to the transmission/reception prohibited state BK, and when the frame cannot be received (in the presence of fault), the ring control unit 33 controls the logical port LP1_1 to the transmission/reception permitted state FW. Similarly, the ring control unit 33 in the relay device SW2 transmits a control frame from the logical port LP1_2 at regular intervals, and monitors the presence or absence of fault in the ring network B (20b) depending on whether the frame can be received at the logical port LP1_2 in the switching device SW1.

When no fault is present in the relay system illustrated in FIG. 2, the FDB in the relay device SW1 retains the information illustrated in FIG. 3C in accordance with the learning process in the FDB processing unit 17. The FDB of FIG. 3C retains both of the MAC addresses “MA1” and “MA2” in association with the logical port LP1_1, and retains the MAC address “MA3” in association with the logical port LP1_2.

### Schematic Configuration of Relay System (Comparative Example)

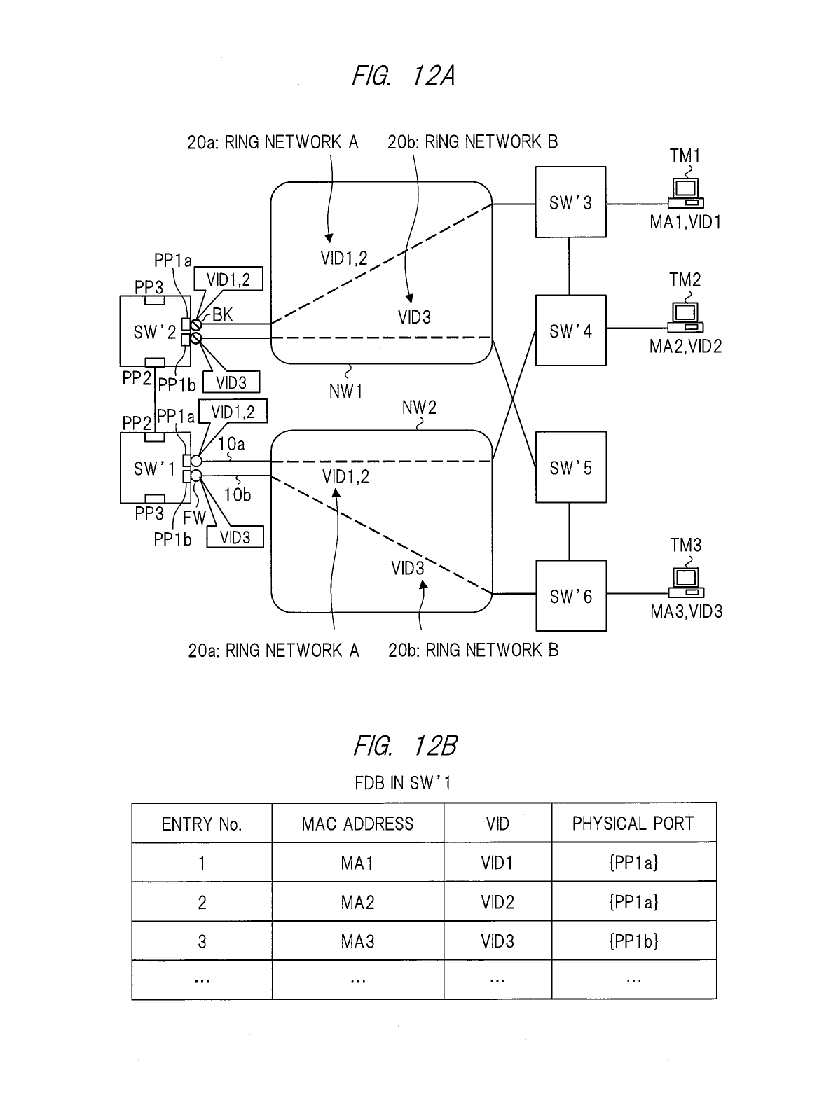

FIG. 12A is a schematic diagram illustrating a configuration example of a relay system studied as a comparative example of FIG. 2, and FIG. 12B is a diagram illustrating an example of contents retained in an FDB in the relay device of FIG. 12A. The relay system illustrated in FIG. 12A is different from the configuration example of FIG. 2 mainly in the port configuration of relay devices SW′1 and SW′ 2 corresponding to the relay devices SW1 and SW2 of FIG. 2. The relay devices SW′ 1 and SW′ 2 both have the configuration to which the logical ports are not applied as illustrated in FIG. 11A.

Specifically, each of the relay devices SW′ 1 and SW′ 2 includes physical ports PP1a and PP1b corresponding to the logical ports LP1_1 and LP1_2 of FIG. 2 and physical ports PP2 and PP3 corresponding to the physical ports PPh2 and PPh3 of FIG. 2, respectively. The physical port PP2 does not include a logical port unlike the physical port PPh2 of FIG. 2, and serves as, for example, a port which makes various communications for realizing the device redundancy between the relay devices SW′1 and SW′2.

The switching device SW′ 2 controls both of the physical ports PP1a and PP1b to the transmission/reception prohibited state BK. In this case, the FDB in the relay device SW′1 retains an entry containing “MA1”, “VID1” and the port identifier {PP1a}, an entry containing “MA2”, “VID2” and the port identifier {PP1a}, and an entry containing “MA3”, “VID3” and the port identifier {PP1b} as illustrated in FIG. 12B.

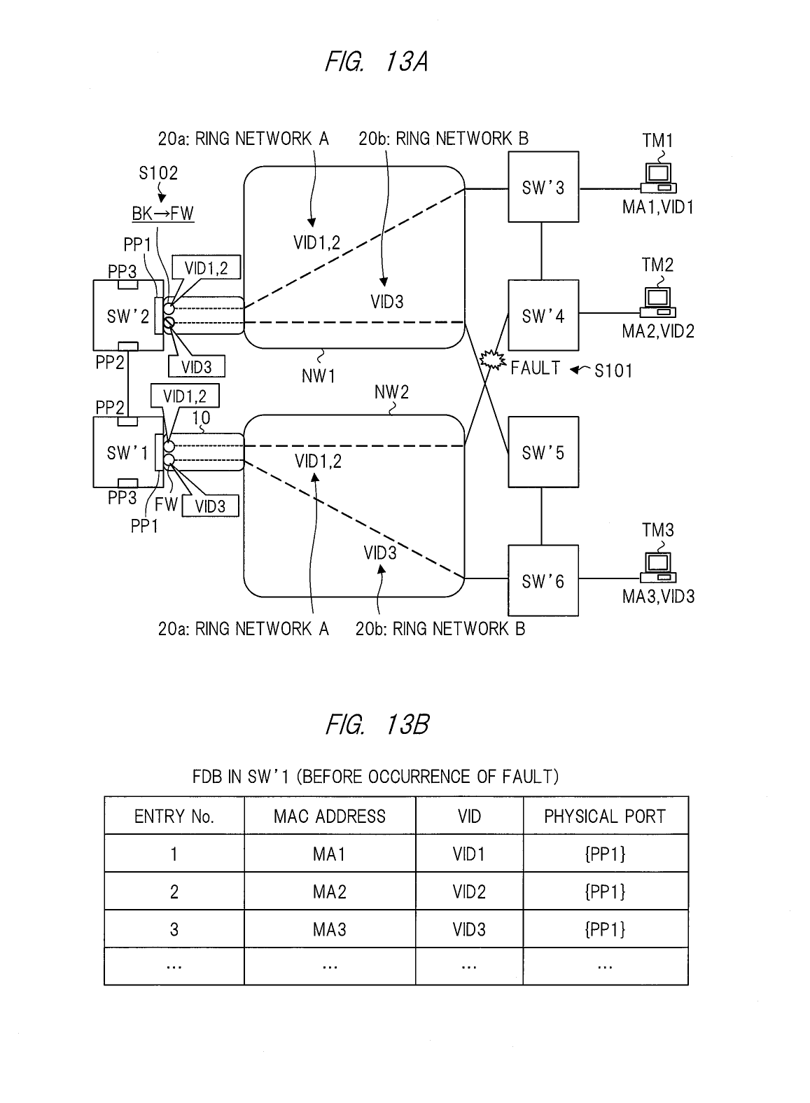

FIG. 13A is a schematic diagram illustrating another configuration example of the relay system studied as the comparative example of FIG. 2, and FIG. 13B is a diagram illustrating an example of contents retained in an FDB in the relay device of FIG. 13A. The relay system illustrated in FIG. 13A has the configuration in which the physical ports PP1a and PP1b of FIG. 12A are replaced with one physical port PP1 in comparison with the configuration example of FIG. 12A. However, the logical ports as illustrated in FIG. 2 are not set for the physical port PP1.

Also, FIG. 13A illustrates a state in which a fault occurs in the ring network A (20a) (here, the communication line between the network NW2 and the relay device SW′4) (step S101). For example, the relay device SW′2 can control the block port in units of VLAN identifier VID. If the fault in step S101 does not occur, the relay device SW′2 controls the transmission/reception operations of the frames with “VID1”, “VID2” and “VID3” at the physical port PP1 into the transmission/reception prohibited state BK. Meanwhile, if the fault occurs (step S101), the relay device SW′2 changes the transmission/reception operations of the frames with “VID1” and “VID2” at the physical port PP1 into the transmission/reception permitted state FW (step S102).

When the fault in step S101 does not occur, the FDB in the relay device SW′1 retains the information illustrated in FIG. 13B. The FDB of FIG. 13B retains the MAC address “MA1” and the VLAN identifier “VID1”, the MAC address “MA2” and the VLAN identifier “VID2”, and the MAC address “MA3” and the VLAN identifier “VID3” in association with the port identifier {PP1}.

Meanwhile, when the fault in step S101 occurs, the relay device SW′1 needs to flush the FDB in accordance with the change in the communication path in step S102. At this time, if the flushing is performed with designating the port identifier {PP1}, the relay device SW′1 flushes also the entry (No. 3) with the MAC address “MA3” belonging to the ring network B (20b) in FIG. 13B.

As a solution to this, a method in which the relay device SW′ 1 performs the flushing with designating the port identifier {PP1} and the VLAN identifiers “VID1” and “VID2” is conceivable. However, when the conditions to be designated increase in this way, a time required for flushing accordingly increases, and a desired required flushing time cannot be satisfied. Although only three VLAN identifiers are used here for convenience of description, more VLAN identifiers are actually used, and thus there is a fear that an enormous time is required for the flushing.

Meanwhile, when the configuration example of FIG. 12A is used, the flushing can be performed with designating the port identifier {PP1}, and thus the problem like this can be solved. In this case, however, the cost increase may occur as described in the first embodiment. Therefore, it is beneficial to use the logical ports illustrated in FIG. 2.

<<Operation in Occurrence of Fault in Relay System>>

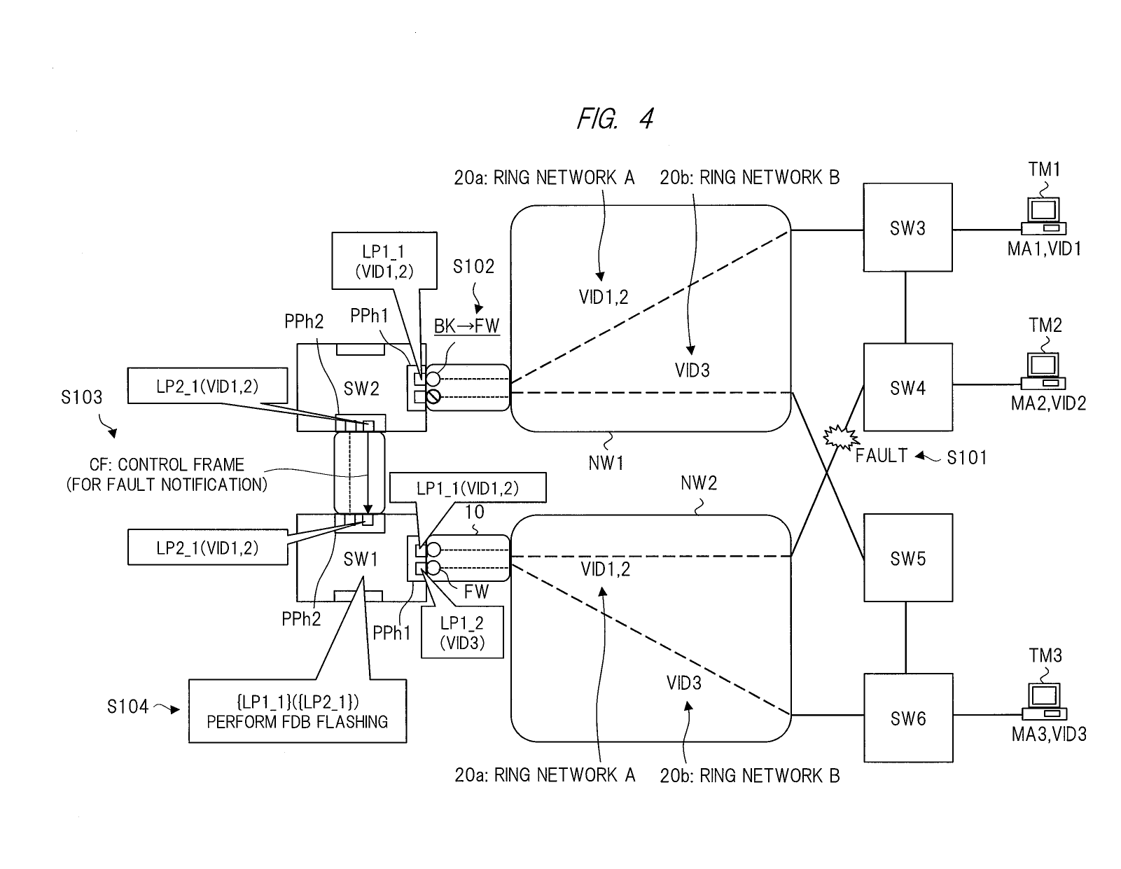

FIG. 4 is an explanatory diagram illustrating a main operation example in the occurrence of fault in the relay system of FIG. 2. In FIG. 4, like the case in FIG. 13A, a fault occurs in the ring network A (20a) (here, the communication line between the network NW2 and the relay device SW4) (step S101). The ring control unit 33 in the relay device SW2 detects the occurrence of the fault by use of a fault monitoring control frame, and changes the logical port LP1_1 from the transmission/reception prohibited state BK to the transmission/reception permitted state FW (step S102). Also, the ring control unit 33 transmits a fault notification control frame CF to the ring network A (20a) (step S103).

When the control frame CF is received at the logical port LP2_1, the ring control unit 33 in the relay device SW1 issues an FDB flush request with designating the logical port {LP1_1} (and {LP2_1}). In other words, when the occurrence of a fault in the ring network A (20a) is detected via the control frame CF, the ring control unit 33 issues an FDB flush request with designating the logical port {LP1_1} (and {LP2_1}) corresponding to the ring network.

At this time, though not particularly limited, the ring control unit 33 in the relay device SW1 retains a correspondence table indicating a correspondence relation between a ring ID identifying the ring network A or B (20a or 20b) and a logical port belonging to each ring ID. Also, the fault notification control frame CF stores a ring ID therein. The ring control unit 33 in the relay device SW1 specifies the logical ports (here, {LP1_1} and {LP2_1}) for which the FDB flush request is to be issued with reference to the correspondence table by use of the ring ID in the received control frame CF. The FDB processing unit 17 of FIG. 3A receives the FDB flush request, and flushes the entries No. 1 and No. 2 in FIG. 3C.

As described above, by use of the relay system according to the second embodiment, the reduction in FDB flush time can be achieved in addition to the reduction in cost described in the first embodiment. Namely, the problem of the increase in cost in FIGS. 12A and 12B and the problem of the increase in FDB flush time in FIGS. 13A and 13B can be both solved. Note that various well-known ring protocols can be applied as the control method of the ring network and the control method is not particularly limited to that described above.

### Third Embodiment

### Detailed Configuration of Relay Device

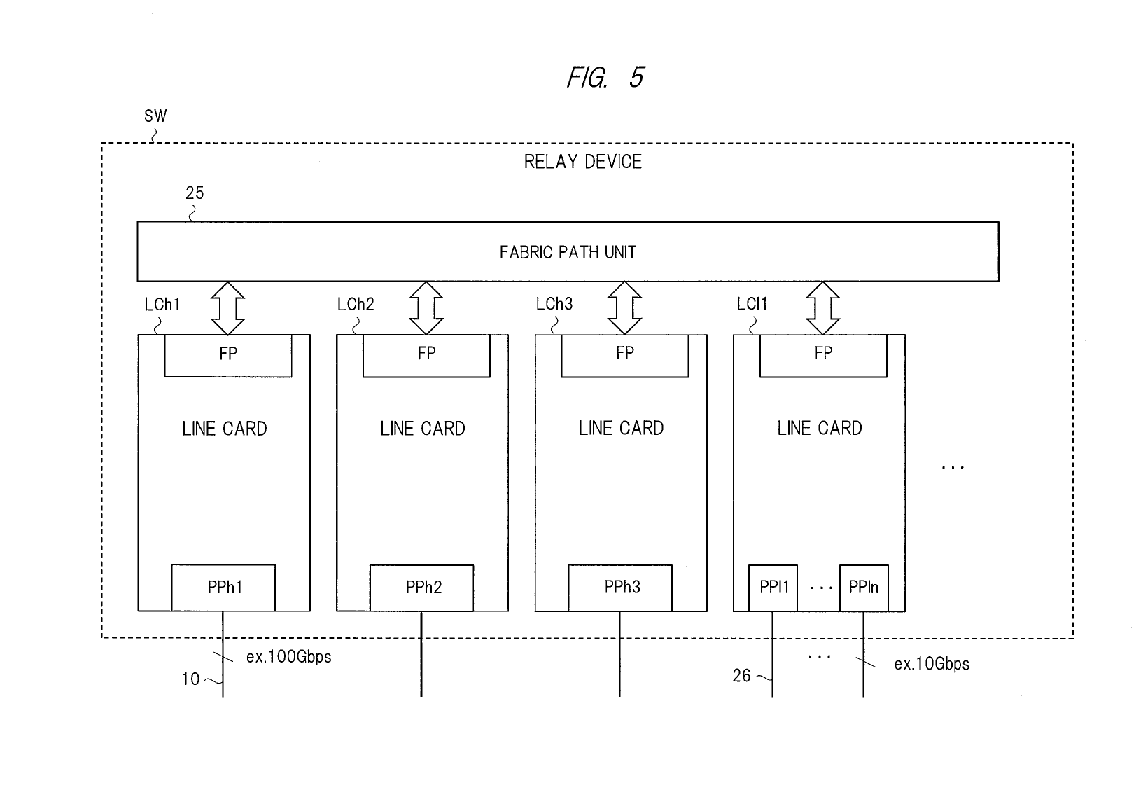

FIG. 5 is a block diagram illustrating a configuration example of main components in a relay device according to the third embodiment of the present invention. The relay device SW illustrated in FIG. 5 is a chassis-type L2 switch in which a plurality of cards are mounted in one chassis. The relay device SW includes one or a plurality of (here, three) high-bandwidth line cards LCh1 to LCh3, one or a plurality of (here, one) low-bandwidth line card LCl1, and a fabric path unit 25. Each of the line cards LCh1 to LCh3 and LCl1 communicates (transmits and receives) a frame with an external device. The fabric path unit 25 relays a frame between the line cards.

Each of the high-bandwidth line cards LCh1 to LCh3 includes the physical ports PPh1 to PPh3 and a fabric terminal FP. The physical ports PPh1 to PPh3 are the ports for which a logical port described in the first embodiment and others is to be set. The physical ports PPh1 to PPh3 are connected to, for example, the communication line 10 of 100 Gbps or the like. Meanwhile, the low-bandwidth line card LCl1 includes n physical ports PPl1 to PPln and a fabric terminal FP. The physical ports PPl1 to PPln are the ports for which a logical port is not to be set. Each of the physical ports PPl1 to PPln is connected to, for example, a communication line 26 of 10 Gbps or the like.

The fabric terminal FP is connected to the fabric path unit 25 and is then connected to the fabric terminal FP of another line card via the fabric path unit 25. The fabric path unit 25 may be configured of, for example, a fabric card having a switching function or may be configured of a wiring board (backplane) having a full-mesh wiring. In the former case, the fabric terminal FP is connected to the fabric card, and is then connected to the fabric terminal FP of another line card via the switching of the fabric card. In the latter case, the fabric terminal FP is configured of a plurality of terminals, and the plurality of terminals are connected to the corresponding terminals of another line card via the full-mesh wiring provided on the backplane.

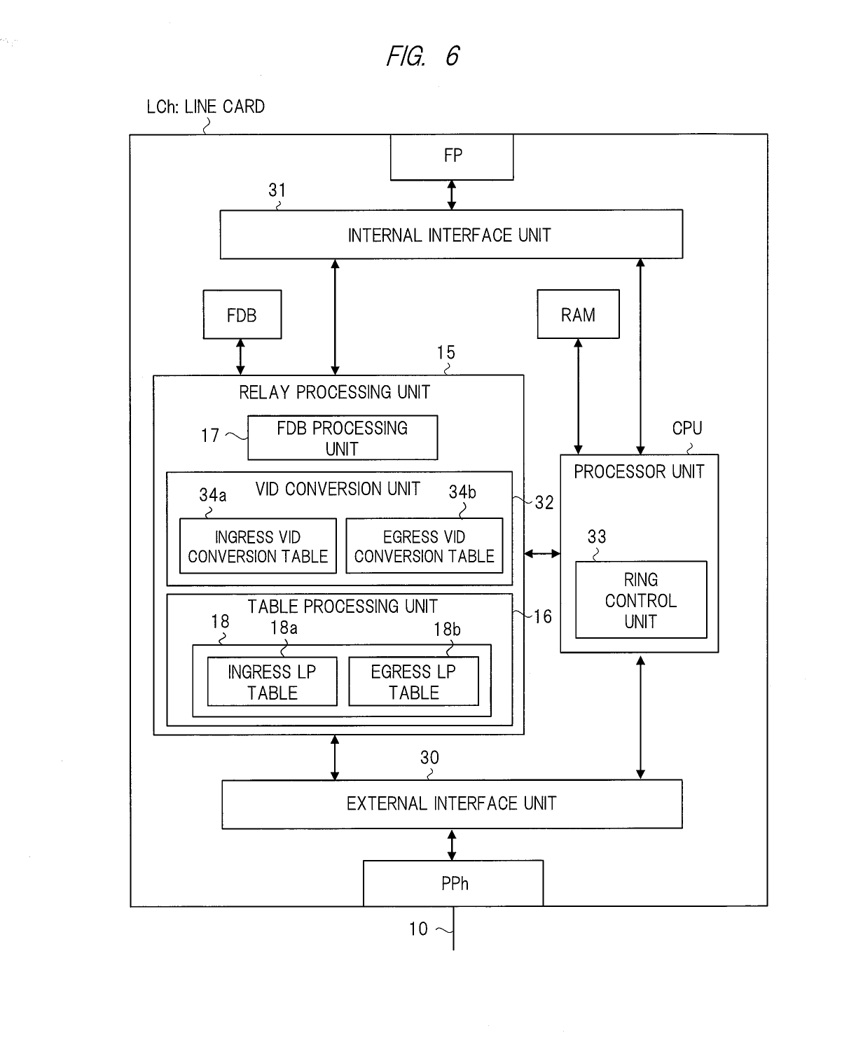

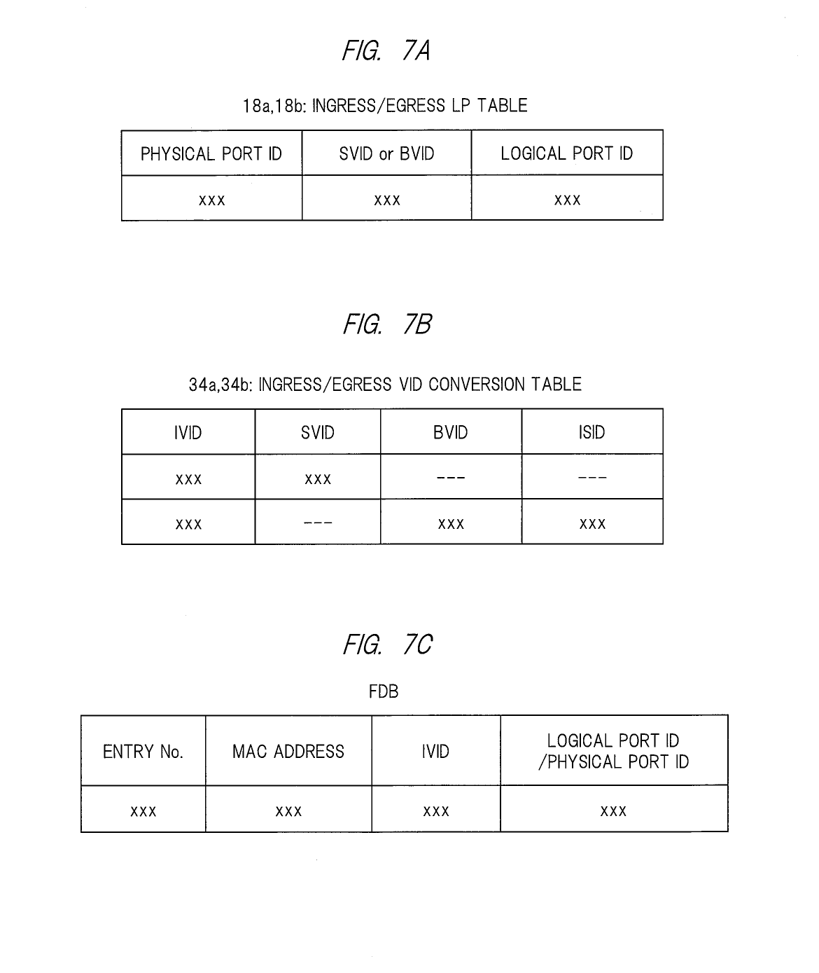

FIG. 6 is a block diagram illustrating a configuration example of a high-bandwidth line card in the relay device of FIG. 5. FIG. 7A is a schematic diagram illustrating a configuration example of ingress/egress LP tables of FIG. 6, FIG. 7B is a schematic diagram illustrating a configuration example of ingress/egress VID conversion tables of FIG. 6, and FIG. 7C is a schematic diagram illustrating a configuration example of an FDB of FIG. 6. In FIG. 6, when a frame is received at the physical port PPh, an external interface unit 30 adds a reception port identifier indicating the line card and the physical port, which have received the frame, to the frame, and transmits it to the relay processing unit 15 or the processor unit CPU. Also, the external interface unit 30 transmits a frame from the relay processing unit 15 or the processor unit CPU to the physical port PPh based on the destination port identifier.

The relay processing unit 15 includes the table processing unit 16, a VID conversion unit 32 and the FDB processing unit 17. The table processing unit 16 includes an ingress LP table 18a and an egress LP table 18b for the LP table 18. When a frame is received at the physical port PPh of its own line card, the table processing unit 16 acquires the port identifier of the logical port from the reception port identifier {PPh} and the VLAN identifier based on the ingress LP table 18a. Meanwhile, when a frame is transmitted from the physical port, the table processing unit 16 acquires the port identifier and the VLAN identifier of the physical port from the destination port identifier (to be the port identifier of the logical port) based on the egress LP table 18b. The table processing unit 16 adds the identifiers acquired in this manner to the frame.

Each of the ingress/egress LP tables 18a and 18b is set by the user in advance, and retains a physical port and a VLAN identifier VID in association with a logical port as illustrated in FIG. 7A. Here, the VLAN identifier VID is assumed as a service VLAN identifier SVID based on the IEEE802.1ad or a backbone VLAN identifier BVID based on the IEEE802.1ah. Namely, though not particularly limited, the relay device SW of FIG. 5 is assumed as a device which can perform the frame relay between a PB (Provider Bridge) network using a service VLAN identifier SVID and a PBB (Provider Backbone Bridge) network using a backbone VLAN identifier BVID.

The VID conversion unit 32 includes an ingress VID conversion table 34a and an egress VID conversion table 34b. Each of the ingress/egress VID conversion tables 34a and 34b is set by the user in advance, and associates a service VLAN identifier SVID, a backbone VLAN identifier BVID and a service instance identifier ISID with an internal VLAN identifier IVID and retains the correspondence relations as illustrated in FIG. 7B.

When the physical port PPh of its own line card is connected to the PB network and a frame is received at the physical port, the VID conversion unit 32 converts the service VLAN identifier SVID into the internal VLAN identifier IVID based on the ingress VID conversion table 34a. Meanwhile, when a frame is transmitted from the physical port, the VID conversion unit 32 converts the internal VLAN identifier IVID into the service VLAN identifier SVID based on the egress VID conversion table 34b.

When the physical port PPh of its own line card is connected to the PBB network and a frame is received at the physical port, the VID conversion unit 32 converts the backbone VLAN identifier BVID and the service instance identifier ISID into the internal VLAN identifier IVID based on the ingress VID conversion table 34a. Meanwhile, when a frame is transmitted from the physical port, the VID conversion unit 32 converts the internal VLAN identifier IVID into the backbone VLAN identifier BVID and the service instance identifier ISID based on the egress VID conversion table 34b. The VID conversion unit 32 adds the identifiers converted in this manner to the frame.

When a frame is received at the physical port PPh of its own line card, the FDB processing unit 17 performs the learning of the FDB and the retrieval of the destination of the frame based on the FDB. Specifically, at the time of the learning of the FDB, the FDB processing unit 17 learns a source MAC address contained in the received frame and the internal VLAN identifier IVID converted by the VID conversion unit 32 in association with the port identifier of the logical port acquired by the table processing unit 16 to the FDB as illustrated in FIG. 7C.

Further, at the time of the retrieval of the destination based on the FDB, the FDB processing unit 17 retrieves the FDB with using the destination MAC address contained in the received frame and the internal VLAN identifier IVID converted by the VID conversion unit as retrieval keys. The FDB processing unit 17 adds the destination port identifier acquired based on the retrieval result to the received frame and then transmits it to the internal interface unit 31. The internal interface unit 31 transmits the frame from the relay processing unit 15 to the fabric terminal FP.

The processor unit CPU includes the ring control unit 33 realized by executing the program stored in a RAM. The ring control unit 33 performs various processes such as transmission/reception of a control frame, issuance of an FDB flush request and control of a block port based on various protocols, thereby controlling the ring network. Note that the external interface unit 30 and the internal interface unit 31 are mounted in, for example, ASIC (Application Specific Integrated Circuit) or the like. In addition, the relay processing unit 15 is mounted in, for example, FPGA (Field Programmable Gate Array) including an integrated RAM or the like, and the FDB is mounted in, for example, CAM (Content Addressable Memory) or the like. A specific mounting form of each unit is not limited thereto, and each unit may be mounted by hardware, software, or the combination thereof as needed.

<<Frame Relay Operation in Relay Device>>

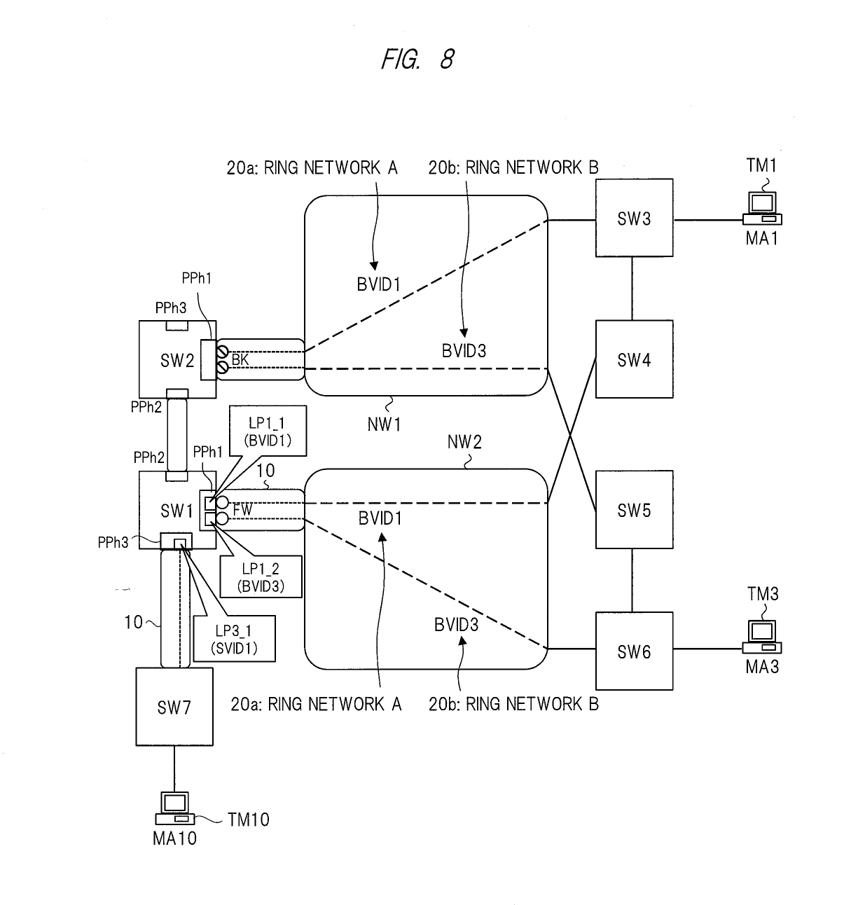

FIG. 8 is a schematic diagram illustrating a configuration example in the case where the relay device of FIG. 5 is applied to the relay system of FIG. 2. For example, the relay system illustrated in FIG. 8 has the configuration in which the relay device SW of FIG. 5 is applied to the relay devices SW1 and SW2 in the relay system of FIG. 2. For example, the ring networks A and B (20a and 20b) belong to the PBB network, and the relay devices SW1 to SW6 are the edge switching devices for relaying a frame between the PBB network and the PB network. Also, the networks NW1 and NW2 are, for example, a PBB-TE (Traffic Engineering) network or the like.

In FIG. 8, for example, a relay device SW7 is connected to the physical port PPh3 of the relay device SW1 via the communication line 10. The relay device SW7 is a switching device belonging to the PB network. A terminal TM10 is connected to the relay device SW7. The terminal TM10 has the MAC address “MA10” and “SVID1” is allocated thereto as the service VLAN identifier SVID.

The physical port PPh3 of the relay device SW1 is a port connected to the PB network, and the physical port PPh1 is a port connected to the PBB network. A logical port LP3_1 is set for the physical port PPh3 as one of the plurality of logical ports, and the logical port LP3_1 is associated with the physical port PPh3 and the service VLAN identifier “SVID1” in the ingress LP table 18a. In addition, the logical port LP1_1 of the physical port PPh1 is associated with the backbone VLAN identifier “BVID1” in the egress LP table 18b. Further, the service VLAN identifier “SVID1” and the backbone VLAN identifier “BVID1” are associated with the internal VLAN identifier “IVID1”.

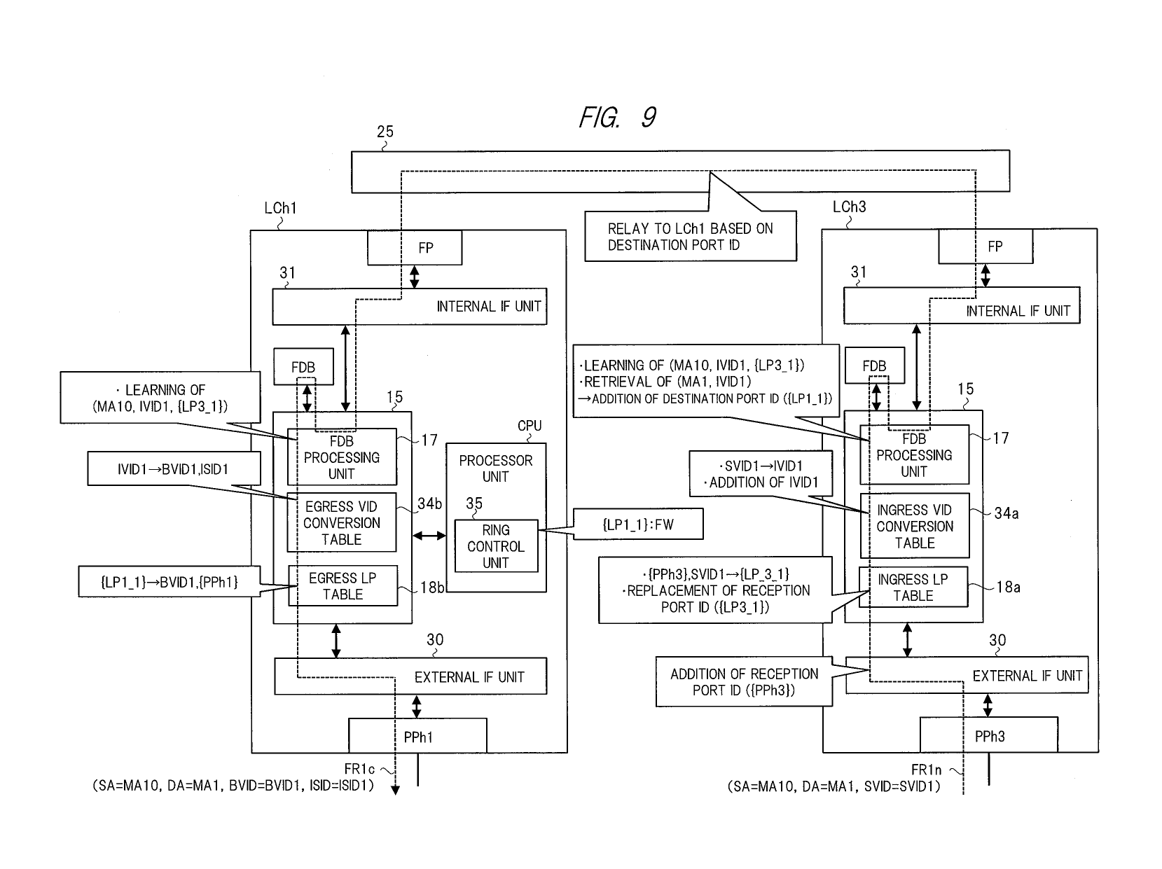

An operation example in the case where a frame is transmitted from the terminal TM10 to the terminal TM1 connected to the ring network A (20a) in the configuration described above will be described. FIG. 9 is an explanatory diagram illustrating a schematic operation example of the relay device of FIGS. 5 and 6. In FIG. 9, first, the line card LCh3 receives a frame (non-encapsulated frame) FR1n from the terminal TM10 at the physical port PPh3. The frame FR1n contains the source MAC address (SA) “MA10”, the destination MAC address (DA) “MA1” and the service VLAN identifier “SVID1”.

The external interface unit 30 adds the reception port identifier {PPh3} to the received frame and then transmits it to the relay processing unit 15. In the relay processing unit 15, the table processing unit 16 acquires the port identifier {LP3_1} of the logical port LP3_1 from the reception port identifier {PPh3} and the service VLAN identifier “SVID1” based on the ingress LP table 18a, and replaces the reception port identifier with the port identifier {LP3_1}. The VID conversion unit 32 converts the service VLAN identifier “SVID1” into the internal VLAN identifier “IVID1” based on the ingress VID conversion table 34a, and adds the internal VLAN identifier “IVID1” to the frame.

The FDB processing unit 17 learns the source MAC address “MA10” and the internal VLAN identifier “IVID1” of the frame in association with the reception port identifier {LP3_1} to the FDB. Also, the FDB processing unit 17 retrieves the FDB with using the destination MAC address “MA1” and the internal VLAN identifier “IVID1” of the frame as retrieval keys, and acquires and adds the destination port identifier {LP1_1} to the frame. The relay processing unit 15 transmits the frame to the fabric path unit 25 via the internal interface unit 31 and the fabric terminal FP. The fabric path unit 25 relays the frame to the line card LCh1 based on the destination port identifier {LP1_1}.

The line card LCh1 transmits a frame from the line card LCh3 to the relay processing unit 15 via the fabric terminal FP and the internal interface unit 31. The FDB processing unit 17 learns the source information of the frame like in the case of the line card LCh3. The VID conversion unit 32 converts the internal VLAN identifier “IVID1” into the backbone VLAN identifier “BVID1” and the service instance identifier “ISID1” based on the egress VID conversion table 34b.

More specifically, the relay processing unit 15 includes an encapsulation executing unit. The encapsulation executing unit encapsulates the frame with the backbone VLAN identifier “BVID1”, the service instance identifier “ISID1”, the source BMAC address and the destination BMAC address. The source BMAC address is the MAC address of the relay device SW1, and the destination BMAC address is, for example, the MAC address of the relay device SW3.

The table processing unit 16 acquires the port identifier {PPh1} and the backbone VLAN identifier “BVID1” of the physical port PPh1 from the destination port identifier {LP1_1} based on the egress LP table 18b, and replaces the destination port identifier with the port identifier {PPh1}. The relay processing unit 15 transmits the frame (encapsulated frame) to the external interface unit 30.

At this time, if the logical port LP1_1 is controlled to the transmission/reception prohibited state BK by the ring control unit 33, transmission to the external interface unit 30 is not performed and the frame is discarded. The external interface unit 30 deletes unnecessary information added to the frame, and then transmits the frame (encapsulated frame) FR1c from the physical port PPh1 based on the destination port identifier.

Thereafter, the network NW2 of FIG. 8 relays the frame FR1c to the relay device SW4 based on the backbone VLAN identifier “BVID1”, and the relay device SW4 relays the frame to the relay device SW3 based on the backbone VLAN identifier “BVID1” and the destination BMAC address. Since the relay device SW3 has received the frame whose destination BMAC address is destined for its own device, the relay device SW3 decapsulates and converts the frame (encapsulated frame) FR1c into a non-encapsulated frame and relays the non-encapsulated frame to the terminal TM1 based on the destination MAC address “MA1”.

Although the relay operation from the physical port PPh3 to the physical port PPh1 has been described here, the relay operation in the reverse direction is also performed in the same way. With brief description, the table processing unit 16 in the line card LCh1 acquires the port identifier {LP1_1} from the port identifier {PPh1} and the backbone VLAN identifier “BVID1” and the VID conversion unit 32 converts the backbone VLAN identifier “BVID1” and the service instance identifier “ISID1” into the internal VLAN identifier “IVID1”. The FDB processing unit 17 performs learning and retrieval of the FDB and acquires the destination port identifier {LP3_1}.

The fabric path unit 25 relays the frame to the line card LCh3 based on the destination port identifier {LP3_1}. The FDB processing unit 17 in the line card LCh3 performs the learning of the FDB, the VID conversion unit 32 converts the internal VLAN identifier “IVID1” into the service VLAN identifier “SVID1”, and the table processing unit 16 replaces the destination port identifier {LP3_1} with the port identifier {PPh3}. More specifically, the relay processing unit 15 in the line card LCh3 includes a decapsulation executing unit, and converts an encapsulated frame into a non-encapsulated frame. The relaying in the reverse direction is performed through the process like this.

At the time of learning of the FDB, more specifically, in order to synchronize the contents retained in the FDB in each line card, it is desirable to use a learning frame containing only the header portion of a received frame or the like. In the example of FIG. 9, the relay processing unit 15 in the line card LCh3 generates a learning frame, and transmits it to all the line cards except its own line card. The relay processing unit 15 in each line card, which has received the learning frame, learns the source information contained in the learning frame to the FDB in its own line card.

Also, the low-bandwidth line card LCl1 illustrated in FIG. 5 does not include the table processing unit 16 of FIG. 6, and is configured to perform the same processing as that in FIG. 9 based on the port identifier of a physical port instead of that of a logical port. For example, the FDB processing unit 17 in the line card LCl1 learns the MAC address and the internal VLAN identifier IVID in association with the port identifier of the physical port (for example, {PPl1}) to the FDB. Accordingly, as illustrated in FIG. 7C, the port identifier of a logical port (for example, {LP3_1}) and the port identifier of a physical port (for example, {PPl1}) are present in a mixed manner in the FDB in each line card. However, the FDB processing unit 17 in each line card can handle the port identifier of a physical port and the port identifier of a logical port without particularly discriminating them. Thus, the simplification of the process can be achieved.

As described above, by using the relay device and the relay system according to the third embodiment, various advantages described in the first and second embodiments can be obtained in the relay system made up of the PB network and the PBB network.

### Fourth Embodiment

### Schematic Structure of Relay System (Modified Example)

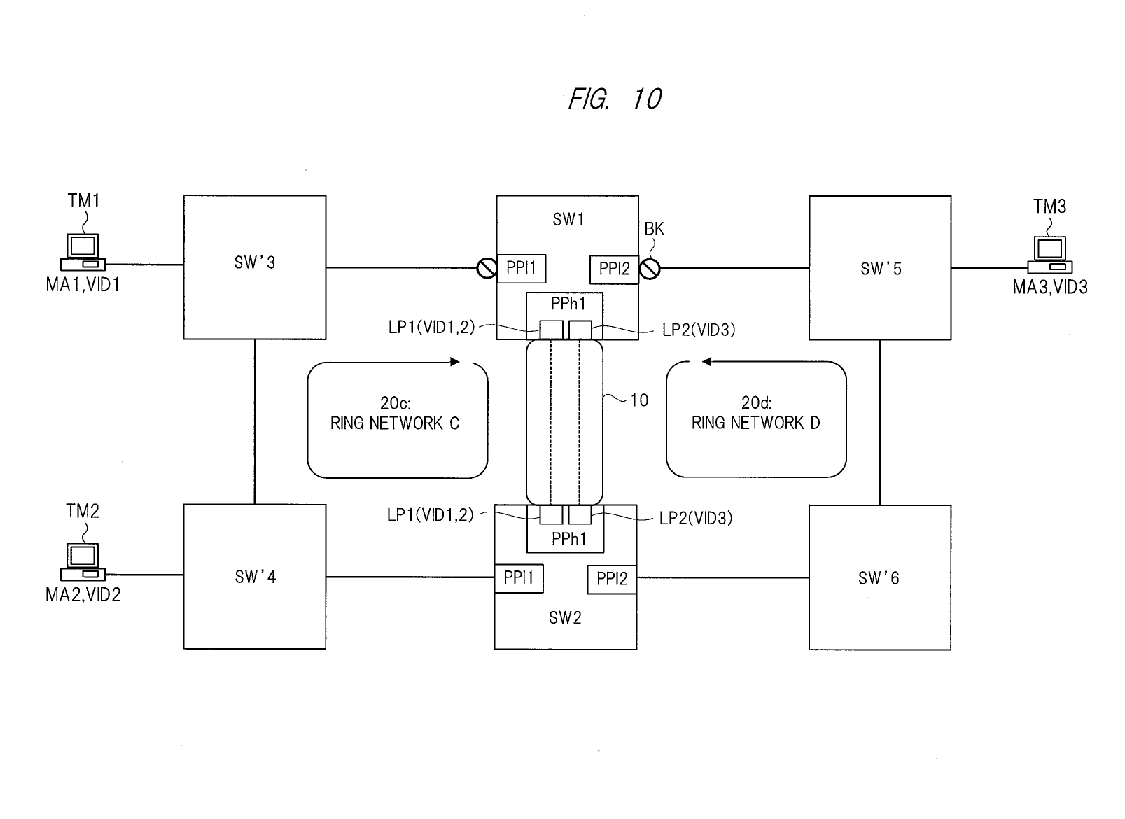

FIG. 10 is a schematic diagram illustrating a configuration example of a relay system according to the fourth embodiment of the present invention. The relay system illustrated in FIG. 10 includes a ring network C (20c) made up of the relay devices SW1→SW′3→SW′4→SW2→SW1 and a ring network D (20d) made up of the relay devices SW1→SW′5→SW′6→SW2→SW1. Each of the relay devices SW1 and SW2 includes the physical port PPh1 and the physical ports PPl1 and PPl2.

The physical ports PPl1 and PPl2 of the relay device SW1 are connected to the relay devices SW′3 and SW′ 5, respectively, and the physical ports PPl1 and PPl2 of the relay device SW2 are connected to the relay devices SW′4 and SW′6, respectively. Also, the physical ports PPh1 of the relay devices SW1 and SW2 are connected via the communication line 10, and the logical ports LP1 and LP2 are set to the physical ports PPh1, respectively.

The logical port LP1 is associated with the physical port PPh1 and the VLAN identifiers “VID1” and “VID2” allocated to the ring network C (20c), and the logical port LP2 is associated with the physical port PPh1 and the VLAN identifier “VID3” allocated to the ring network D (20d). Here, the physical ports PP11 and PP12 of the relay device SW1 are controlled to the transmission/reception prohibited state BK. However, the block port is not particularly limited to the positions, and may be set at any ring port on the ring network C (20c) and any ring port on the ring network D (20d).

In this configuration, the physical port PPh1 serves as a physical ring port shared among a plurality of ring networks, and thus problems similar to those of the case of FIGS. 13A and 13B may arise. Namely, when the FDB flushing is performed in units of physical port, entries are excessively flushed, and when the FDB flush is performed with the combination of the physical port and the VLAN identifier VID, a time required for the FDB flushing is increased. Then, by using the logical port, such problems can be solved like in the second embodiment.

In the foregoing, the invention made by the inventors of the present invention has been concretely described based on the embodiments. However, it is needless to say that the present invention is not limited to the foregoing embodiments and various modifications and alterations can be made within the scope of the present invention. For example, the embodiments above have been described in detail so as to make the present invention easily understood, and the present invention is not limited to the embodiment having all of the described constituent elements. Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration.

For example, the example in which the relay device provided with a logical port setting function is applied to the ring networks has been described here, but the relay device is applicable to various networks other than the ring networks. In addition, although an L2 switch is taken as an example of the relay device here, a layer 3 (L3) switch for performing an L3 processing in addition to the L2 processing of the OSI reference model is also applicable.

What is claimed is:

1. A relay device comprising:
a physical port;
a logical port table retaining a combination of the physical port and a VLAN identifier in association with a logical port;
a table processing unit;
an FDB retaining a correspondence relation between a MAC address and the logical port; and
an FDB processing unit,
wherein when a frame is received at the physical port, the table processing unit acquires the logical port from the physical port which has received the frame and the VLAN identifier contained in the frame based on the logical port table, and
the FDB processing unit learns a source MAC address contained in the frame in association with the logical port acquired by the table processing unit to the FDB.

2. The relay device according to claim 1,
wherein the logical port table retains a combination of the one physical port and one or a plurality of the VLAN identifiers in association with the one logical port.

3. The relay device according to claim 1,
wherein the VLAN identifier retained in the logical port table is a service VLAN identifier based on IEEE802.1ad or a backbone VLAN identifier based on IEEE802.1ah.

4. The relay device according to claim 1,
wherein the physical ports include a physical port for which the logical port is to be set and a physical port for which the logical port is not to be set, and
the FDB retains a correspondence relation between the MAC address and the physical port for the physical port for which the logical port is not to be set.

5. The relay device according to claim 1,
wherein the physical port is a ring port connected to a ring network.

6. The relay device according to claim 5, further comprising:
a ring control unit controlling the ring network based on a predetermined ring protocol,
wherein when occurrence of a fault in the ring network is detected, the ring control unit issues a request for flushing the FDB with designating the logical port.

7. A relay system comprising a plurality of relay devices connected via a communication line,
wherein at least one of the plurality of relay devices includes:
a physical port connected to another relay device via the communication line;
a logical port table retaining a combination of the physical port and a VLAN identifier in association with a logical port;
a table processing unit;
an FDB retaining a correspondence relation between a MAC address and the logical port; and
an FDB processing unit,
when a frame from another relay device is received at the physical port, the table processing unit acquires the logical port from the physical port which has received the frame and the VLAN identifier contained in the frame based on the logical port table, and
the FDB processing unit learns a source MAC address contained in the frame in association with the logical port acquired by the table processing unit to the FDB.

8. The relay system according to claim 7,
wherein the logical port table retains a combination of the one physical port and one or a plurality of the VLAN identifiers in association with the one logical port.

9. The relay system according to claim 7,
wherein the VLAN identifier retained in the logical port table is a service VLAN identifier based on IEEE802.1ad or a backbone VLAN identifier based on IEEE802.1ah.

10. The relay system according to claim 7,
wherein the plurality of relay devices configure a plurality of ring networks,
at least one of the plurality of relay devices further includes a ring control unit controlling the plurality of ring networks based on a predetermined ring protocol, and
the physical port is a ring port shared among the plurality of ring networks.

11. The relay system according to claim 10,
wherein when occurrence of a fault in any of the plurality of ring networks is detected, the ring control unit issues a request for flushing the FDB with designating the logical port.

12. The relay system according to claim 10,
wherein the plurality of logical ports corresponding to the plurality of ring networks are set in the logical port table, and
when occurrence of a fault in any of the plurality of ring networks is detected, the ring control unit issues a request for flushing the FDB with designating the logical port corresponding to the ring network.

13. The relay device according to claim 2,
wherein the VLAN identifier retained in the logical port table is a service VLAN identifier based on IEEE802.1ad or a backbone VLAN identifier based on IEEE802.1ah.

14. The relay system according to claim 8,
wherein the VLAN identifier retained in the logical port table is a service VLAN identifier based on IEEE802.1ad or a backbone VLAN identifier based on IEEE802.1ah.
